(19) United States
(12) Patent Application Publication
(10) Pub. No.: US 2018/0264871 A1
(43) Pub. Date: Sep. 20, 2018

(54) Pen with Cleaning Agent

(71) Applicant: Anton Preisinger, Seattle, WA (US)

(72) Inventor: Anton Preisinger, Seattle, WA (US)

(21) Appl. No.: 15/461,529

(22) Filed: Mar. 17, 2017

(51) Int. Cl. B43K 1/00

(52) U.S. Cl. CPC B43K 1/006

(57) ABSTRACT

The current invention are pens that have a cleaning agent in the ink. The pens have a hollow central tube that holds the ink, an end cap with an eraser, and an end cap that covers the coloring tip. The eraser cap is removable, allowing replacement of the ink. The pen would greatly reduce the risk of stains, and would actually clean many surfaces it is used to color. The pen could be used in a free artistic manner, or a user could pair it with transparent templates that hang on walls. The templates could include classic children staples, such as connect the dots and coloring pages. The templates could be used for older children in practicing art or with specially designed learning/studying templates.

### CROSS-REFERENCES TO RELATED APPLICATIONS (IF ANY)

None.

### BACKGROUND

### 1. Field of the Invention

This invention relates to pens and particularly ones that are intended for children to use on walls with a cleaning solution to clean up.

### 2. Description of Prior Art

Children love to write on everything and everywhere leading sometimes to massive clean ups or repairs as permanent markers are porous pens that can write on surfaces such as glass, plastic, wood, metal, and stone. The ink is generally resistant to rubbing and water, and can last for many years and difficult to clean up.

Several major companies, such as Crayola, have crayons and markers that are designed and marketed for children to use to write on bathtubs and bathroom walls. The markings are easily washed from the walls.

There are also special paints on the market that allow a wall to be more easily cleaned when written on, by acting like a chalkboard or a dry-erase surface.

But there is nothing which combines the writing pen with cleaning solutions.

There is still room for improvement in the art.

### SUMMARY OF THE INVENTION

The current invention are pens that an individual can use to write, color, or draw on certain household surfaces. The pens have an ink with a cleaning agent, which allows easy cleaning of the marks, as well as assisting in cleaning other residual buildup.

The marker has an outer casing consisting of three parts. There is a central tube and a cap on each end. The central tube houses the writing fluid. The “writing end” of the tube tapers, so the writing fluid is held in place while in use. The cap on the “writing end” is fitted to be securely held on the outside of the tube, but easily removed from the tube. The cap on the “eraser end” would be fitted to be securely held on the inside of the tube. This cap is removed when changing out the writing fluid. This cap has an eraser to remove writing fluid.

The writing fluid can be of any variety of color and can be rapidly changed out based on user choice. All the writing fluid would have a cleaning agent.

This product can be used to the free creativity of the user or it can be paired with separate designs. Designs would be on transparent plastic sheets and could include things such as connect-the-dots, color by number, or even designs for visual or kinetic learning.

### BRIEF DESCRIPTION OF THE DRAWINGS

Without restricting the full scope of this invention, the preferred form of this invention is illustrated in the following drawings:

FIG. 1 is a right angled front perspective view of the Pen showing my new design thereof;

FIG. 2 is a top view with the bottom view being a mirrored opposite thereof; and

FIG. 3 is a left side view with the right side view being a mirror image thereof;

FIG. 4 is a left angled back perspective view thereof;

FIG. 5 is a back view thereof;

FIG. 6 is a front view thereof; and

FIG. 7 shows the pen with the caps.

### DESCRIPTION OF THE PREFERRED EMBODIMENT

There are a number of significant design features and improvements incorporated within the invention.

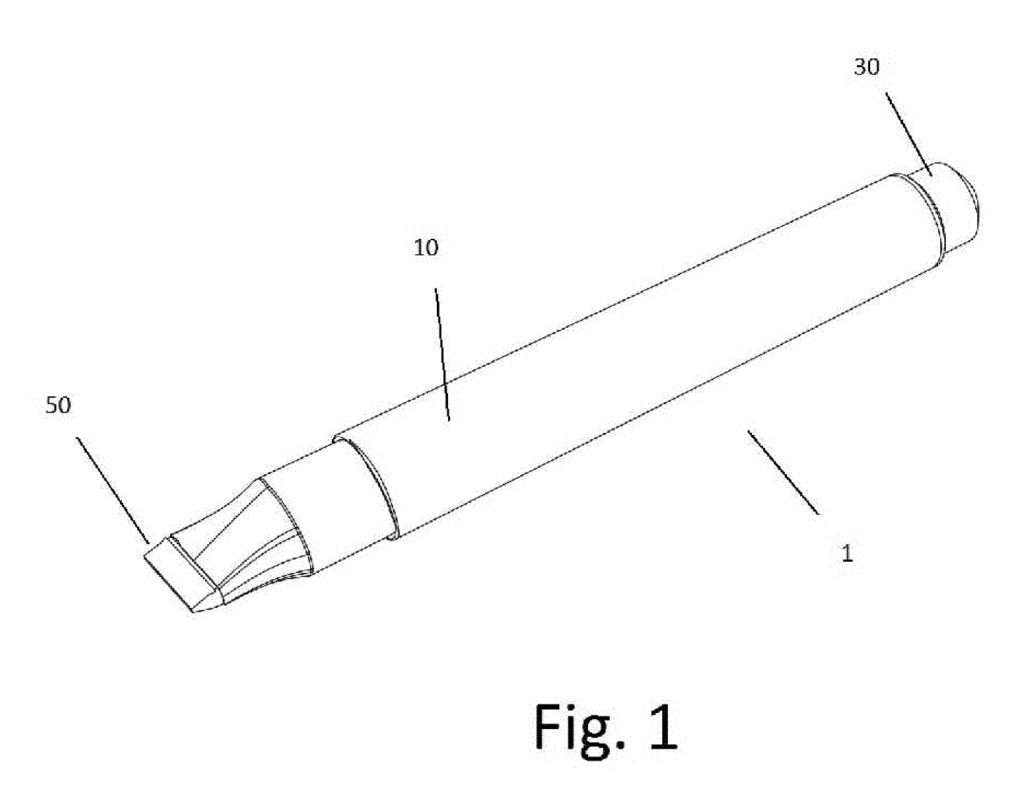

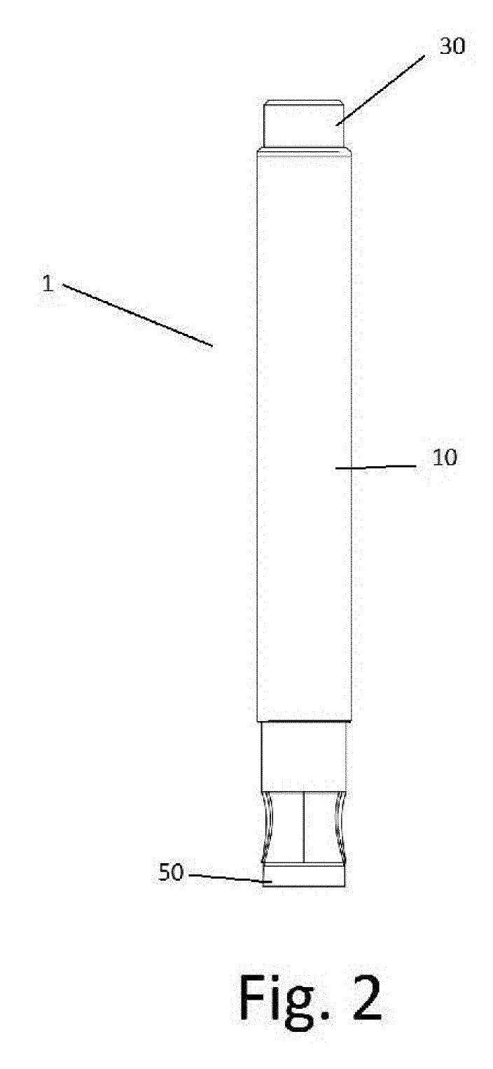

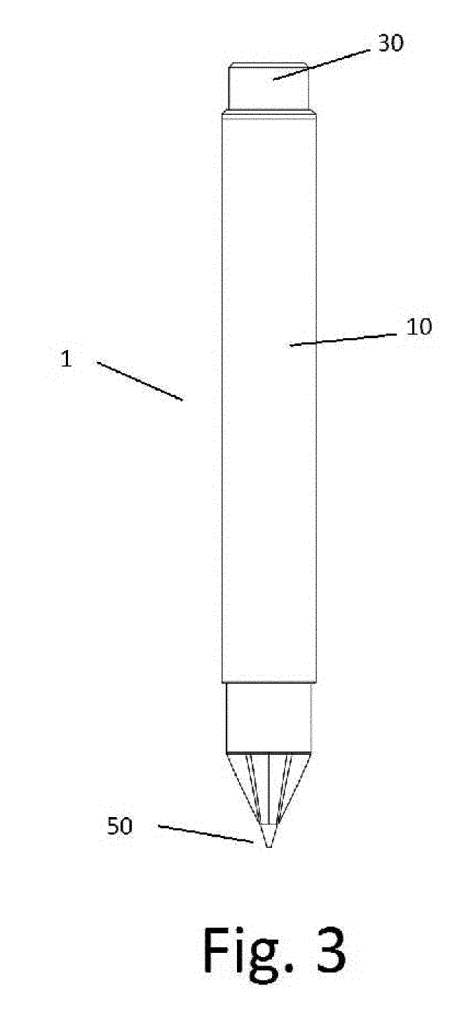

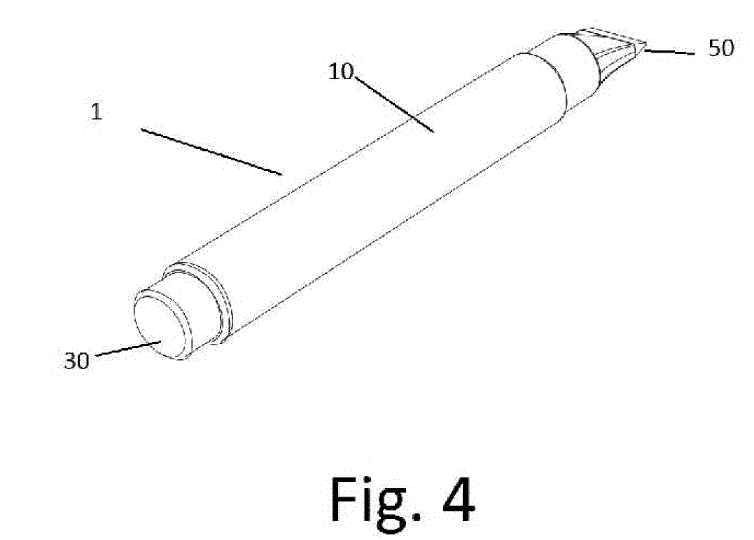

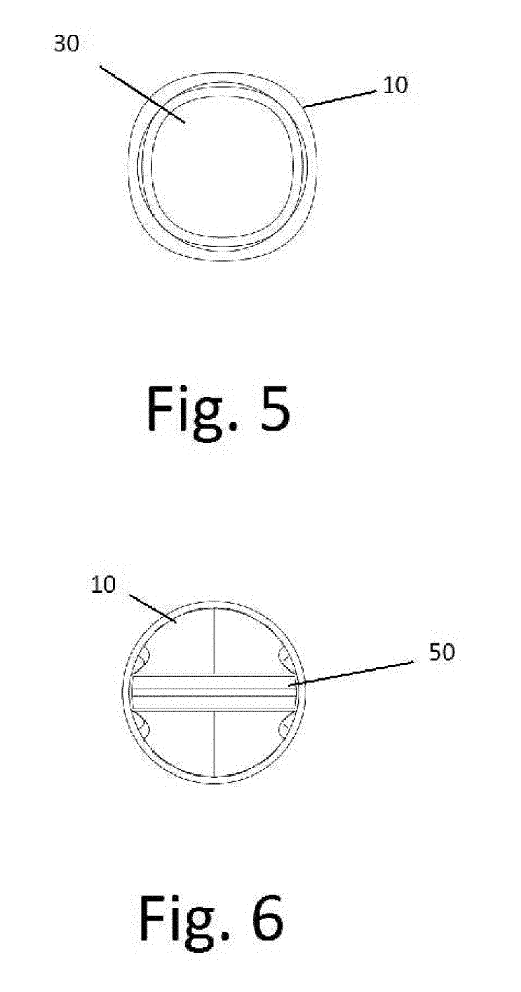

The current invention is an innovative pen with cleaning agent as shown in FIGS. 1 through 7.

The current invention are pens 1 that an individual can use to write, color, or draw on certain household surfaces. The pens 1 have an ink with a cleaning agent, which allows easy cleaning of the marks, as well as assisting in cleaning other residual buildup.

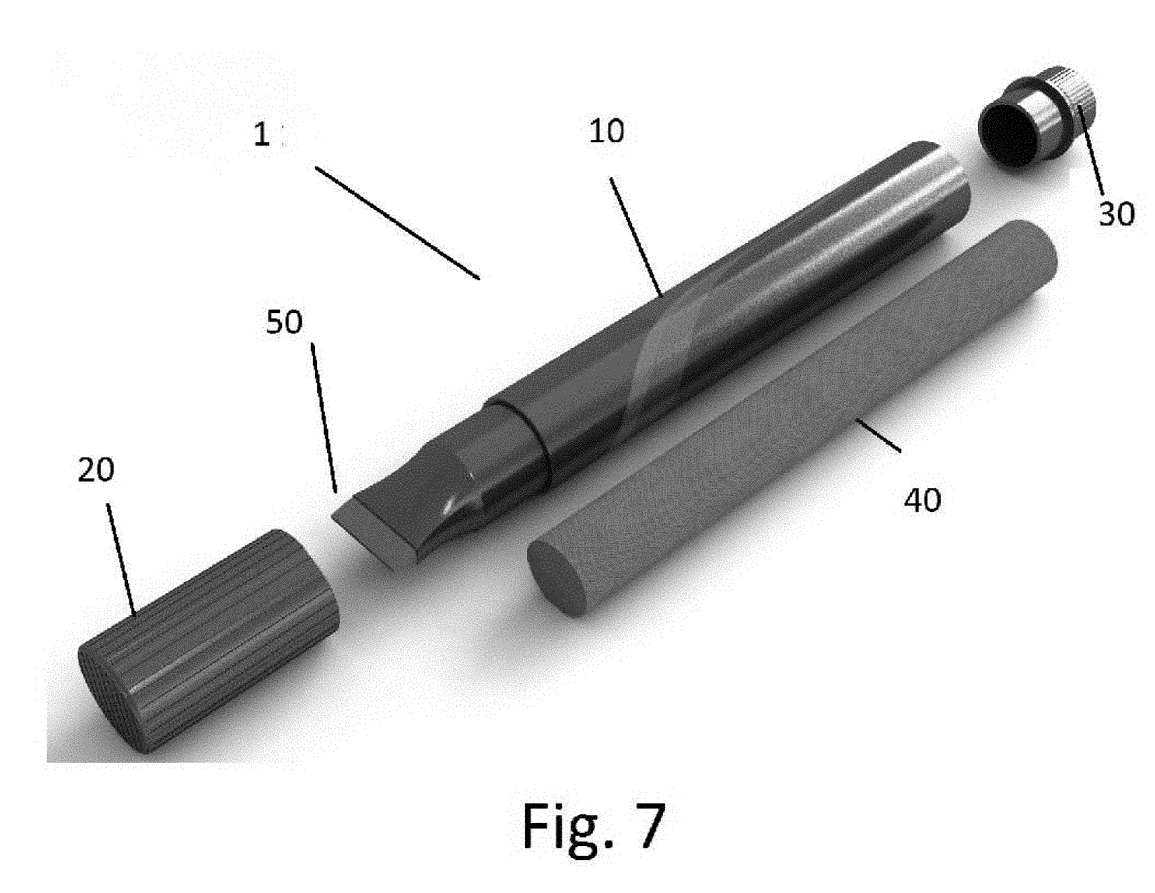

The marker 1 has an outer casing consisting of three parts. There is a cylindrical central tube 10 and a cap on each end as shown in FIG. 7. The central tube 10 houses the writing fluid with cleaning agent which, in the preferred embodiment, is stored within the central tube 10 either by itself or absorbed and stored in a felt cylinder 40. The writing end of the tube tapers to a writing tip 50. The writing end cap 30 on the writing end is fitted to be securely held on the outside of the tube 10, but easily removed from the tube 10.

The writing ink with cleaning agent is transferred from the inside of the central tube 10 to the tip 50 through adsorption.

The cap 30 on the “eraser end” would be fitted to be securely held on the inside of the tube. This cap is removed when changing out the writing fluid. This cap 30 has an eraser to remove writing fluid.

The user would remove the writing cap 20 and use the pen 1 to write on any surface using the tip 50. The user can use the eraser end 30 to erase any unwanted ink from a surface.

The writing fluid can be of any variety of color and can be rapidly changed out based on user choice. The writing fluid is non-toxic and contains a cleaning agent

This product can be used to the free creativity of the user or it can be paired with separate designs. Designs would be on transparent plastic sheets and could include things such as connect-the-dots, color by number, or even designs for visual or kinetic learning.

Advantages

The innovative pens allow a child to write on household surfaces without causing hard to clean stains, allowing parents to relax while giving children a greater range of freedom. Have a self-cleaning agent and eraser makes it so the pen is not only easily cleaned, but can also help clean the surfaces. The inclusion of a cleaning agent marks a fundamental shift from other products which are simply less difficult to clean. Thus, this product is less restricted in where it can be used than other products, such as bath time crayons and markers, because of the self-cleaning agent.

Although the present invention has been described in considerable detail with reference to certain preferred versions thereof, other versions are possible such as different tension means, bobber shapes and sizes and different colored lights. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

That which is claimed is:

1. A pen comprising:
A central tube with two end, where one end has a removable cap with an eraser on it and the other end has a tip.

2. A device according to claim 1 comprising:
Filling the central tube with a writing fluid.

3. A device according to claim 2 comprising:
Having the fluid be ink.

4. A device according to claim 2 comprising:
Having the writing fluid be a color cleaning solution.
